(19) United States
(12) Patent Application Publication
(10) Pub. No.: US 2008/0319984 A1
(43) Pub. Date: Dec. 25, 2008

(54) SYSTEM AND METHOD FOR REMOTELY GATHERING INFORMATION OVER A COMPUTER NETWORK

(76) Inventors: James W. Proscia, Dearborn, MI (US); John E. Nemazi, Bloomfield Hills, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 12/106,297

(22) Filed: Apr. 19, 2008

Related U.S. Application Data
(60) Provisional application No. 60/913,267, filed on Apr. 20, 2007.

(51) Int. Cl. G06F 7/10; G06F 17/30

(52) U.S. Cl. 707/5; 707/10; 707/E17.014; 707/E17.008

(57) ABSTRACT

A method of finding relevant content on one or more target storage devices includes the step of receiving an instruction from an instruction queue specifying a content description to be searched for on the target digital storage medium. Content on the target digital storage medium specified by the content description is then search for. A report of the search is created and transferred to one or more predetermined users after the report is created. A discovery hold is implement by preserving content found in the search.

### TECHNICAL FIELD

The present invention relates to general systems and methods for gathering information and, more specifically, to a system and method for gathering information remotely from one or more target devices.

### BACKGROUND OF THE INVENTION

With the recent amendments to the Federal Rules of Civil Procedure, electronic discovery (e-discovery) has become an integral part of the civil litigation process, fostered by an awareness among legal experts that nearly all evidence is digital in nature. Furthermore, companies are now legally responsible for diligently complying with requests to produce reasonably accessible computer-based data. In conducting electronic discovery, problems often arise with respect to the vast quantities of electronic documents that must be reviewed, whether for a party's document production in litigation against another party, for satisfying government reporting requirements, or for any other relevant legal purpose. A party's ability to manage information in these scenarios often depends on how readily it can capture, review, assess, and produce relevant documentation.

As mentioned above, the computer-based discovery process often involves searching through vast amounts of data. Some current methods accomplish this task by compiling all of the information from many devices and loading the net information onto one or more storage servers for indexing and searching. Traditional search methods are often rudimentary and unfit for the electronic discovery process, often leading to the undesired production of irrelevant or erroneous documentation. A large search result can leave a party with a false sense of security but may later come back to haunt the party in the form of court-authorized sanctions, often resulting in the party's loss of control over an e-discovery process. Additionally, the cost of printing and archiving, coupled with the cost of a legal staff, can pose exorbitant costs during a discovery process. The production of erroneous documentation can therefore be absolutely detrimental to a party.

The gathering of impartial or erroneous data, as noted above, can have profound implications on an electronic discovery process. Typically, metadata, or information associated with a given file, is stored on the file's host device. Metadata can include information, such as a file's creation date, author, or storage path. Some current methods of e-discovery limit search processes to a file's metadata and, in turn, miss information that could be crucial to a discovery process. Often, the relevant content is not stored in the metadata, but rather in the actual file data.

Other current methods of e-discovery implement metadata searches in addition to full-text searches. In searching the text of the files, these methods sometimes alter the file information and, in the process, render the file ineffective for the purpose of court admissibility. Additionally, current methods often archive vast amounts of data, as mentioned above, resulting in an unusable mass of information. What is desired, as recognized by the present inventors, is a streamlined method of searching for relevant data without altering the substance of the targeted information and its associated metadata.

In addition to being expensive, obsolete, and often inaccurate, the current methods of electronic discovery can be highly disruptive of business operations. Many e-discovery solutions require physical access to each target device for analysis by a consultant or expensive software program. The overhead cost of such a scenario, along with the business disruption in such circumstances, is often immense and unwarranted, particularly in situations involving large corporate-wide servers or tape drives. Additionally, these types of investigations often result in significant loss of workplace morale when employees feel threatened by such an explicitly intrusive investigation process

Even enterprise solutions for electronic discovery can result in unnecessary business disruption. E-discovery enterprise software packages typically require a dedicated, synchronous connection between an investigative software program and an end-user device. This constraint forces the requirement of transmitting vast amounts of data to and from the enterprise program during peak hours, when users may be engaged at their workstations. Additionally, many “feedback” data transfers are required to ensure security and connectivity between the enterprise software and the multiple end-user devices. On a corporate-scale, maintaining synchronous connections on such a large magnitude, each having an active-data transfer requirement, can slow down even the most advanced networks and disrupt end-user productivity.

The need to maintain a synchronous connection between an enterprise software program and an end-user device imposes yet another limitation on the e-discovery process. Presently, many portable devices; such as laptop computers, personal digital assistants, and browser-enabled phones; permit a user to conduct business at a remote location. The portable device may often contain information that is relevant to an e-discovery process. Some of the present enterprise software programs for e-discovery can only extract information from devices that are on the same network as the software program. The network, in this case, may be limited to devices connected to one another in a company's internal network.

In many instances, the device may not be operating within a company's internal network, thus precluding the enterprise program from obtain information stored on the device. Even if an enterprise program can connect to a device on a general worldwide network, the device may not be connected long enough for the software to fully acquire relevant information. For a device containing a large amount of relevant information, using such an enterprise program to extract this information could lead to an undesirably lengthy process. Thus, the inventors have recognized an additional need for a method of obtaining information from one or more target devices without relying upon synchronous network connections to facilitate the transfer of information.

### SUMMARY OF THE INVENTION

The present invention solves one or more problems of the prior art by providing in one embodiment a method of locating electronically stored information. The method of this embodiment includes a step of receiving an instruction from an instruction queue. The instruction specifies a content description to be searched for on a target digital storage medium. Electronically stored information specified by the content description is subsequently search form on the target digital storage medium. A report of found electronically stored information is created and then transferred to one or more predetermined users after the log is created. Typically, these steps of the present embodiment are encoded on a computer readable medium and are performed without user intervention.

In another embodiment of the present invention, another method of locating electronically stored information is provided. The method of this embodiment includes a step of accessing an email message from an email inbox. The email message has one or more instructions attached to or contained therein. An instruction is received from the email message. Characteristically, the instruction specifies a content description to be searched for on a target digital storage medium. Electronically stored information specified by the content description is subsequently search form on the target digital storage medium. A report of found electronically stored information is created and then transferred to one or more predetermined users after the log is created. Typically, these steps of the present embodiment encoded on a computer readable medium and are performed without user intervention.

In yet another embodiment of the present invention, another method of locating electronically stored information is provided. The method of this embodiment includes a step of receiving an instruction from an instruction queue. The instruction specifies a content description to be searched for on a target digital storage medium. Electronically stored information specified by the content description is subsequently search form on the target digital storage medium. Electronically stored information found by the search is then preserved. The method of the present embodiment is particularly useful for responding to a litigation discovery hold. Typically, these steps of the present embodiment are encoded on a computer readable medium and are performed without user intervention.

### BRIEF DESCRIPTION OF DRAWINGS

FIG. 1 shows a diagram of an environment in which embodiments of the present invention may operate;

FIG. 2A shows an embodiment of the present invention, being a system for asynchronously gathering information from one or more target devices;

FIG. 2B shows an embodiment of the present invention wherein the system of FIG. 2A utilizes a second message queue to facilitate communication;

FIG. 2C shows an embodiment of the present invention wherein the system of FIG. 2A includes an error queue in communication with a target device;

FIG. 2D-2E show embodiments of the present invention wherein the system of FIG. 2A includes a security monitor to ensure the correctness one or more recipients of an instruction message;

FIG. 3A-3B show exemplary scenarios in which a servelet executes an instruction in a manner consistent with the present invention;

FIG. 3C shows a flow diagram of an exemplary method used by a servelet to accept and process an incoming message in a manner consistent with the present invention;

FIG. 4 shows a diagram of a target device wherein a servelet on the target device includes a priority module;

FIG. 5A illustrates part of a computer software program used to generate an instruction message in a manner consistent with the present invention;

FIG. 5B illustrates an e-mail message used to communicate a set of instructions between a sender device and a target device in a manner consistent with the present invention; and

FIG. 6 illustrates an exemplary method used by a recipient device to process incoming messages in a manner consistent with the present invention.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a”, “an”, and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

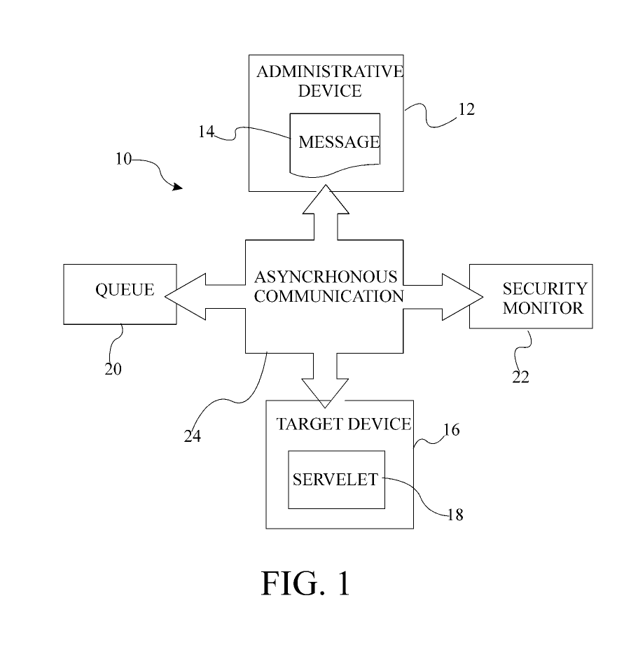

FIG. 1 illustrates an embodiment of an electronically stored information (“ESI”) locating system. ESI-locating system 10 includes one or more administrative devices 12, target devices 16, queues 20, and security monitors 22 in asynchronous communication 24. For diagrammatic simplicity, one administrative device 12, one target device 16, one queue, 20, and one security monitor 22, are shown in asynchronous communication 24. Typically, however, there may be more entities in asynchronous communication.

In FIG. 1, administrative device 12 may include any device, such as a mainframe, personal computer, laptop, personal digital assistant, or the like, capable of sending message 14 to queue 20 or receiving message 14 from queue 20. Administrative device 12 is referred to hereinforth as “sender device” and/or “recipient device”. It should be understood that this is not meant to limit the scope of the invention, but rather to further clarify the following disclosure.

Message 14 can include any entity having information stored therewithin, such as an electronic mail (e-mail) message, a data stream, a computer file, or the like. The information need not be in the form of text in the conventional sense. The information may be communicated in “raw data” form as binary, hexadecimal, or the like. The information may be encrypted with an encryption protocol, such as MD5, SHA-1, DES, or any other encryption protocol known in the art.

In a variation of the present embodiment, queue 20 is a buffer that stores message 14 for processing at a later time. Queue 20 may include, for example, an e-mail inbox, a file transfer protocol (FTP) server location, or any other element that can facilitate asynchronous communication 24 between any two entities. As used herein, “asynchronous communication” refers to two-way communication that allows two participants to respond at their own convenience and with a time delay, thus allowing two parties to communicate without maintaining a constant connection. The communication may use standard communication protocols, such as SMTP, TCP/IP, IMAP, or the like.

Target device 16 can include any device, such as a computer, mainframe, or personal digital assistant, or the like, having information encoded thereon and capable of communicating with one or more queues 20. Typically, target storage device 16 includes one or more target digital storage media that is accessible to a user computer. Such target digital storage medium has encoded thereon electronically stored information to be located by the system of the present invention. Target device 16 may also host servelet 18, which, in the scope of the present invention, can be regarded as a passive software program capable of executing instructions delivered thereto. Security monitor 22 may be a network administrator or equivalently trusted individual. Security monitor 22 could also be software programmed to facilitate security between two parties.

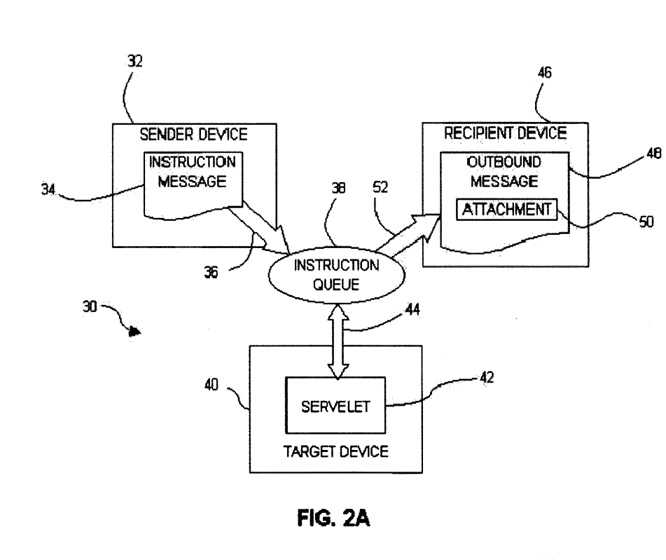

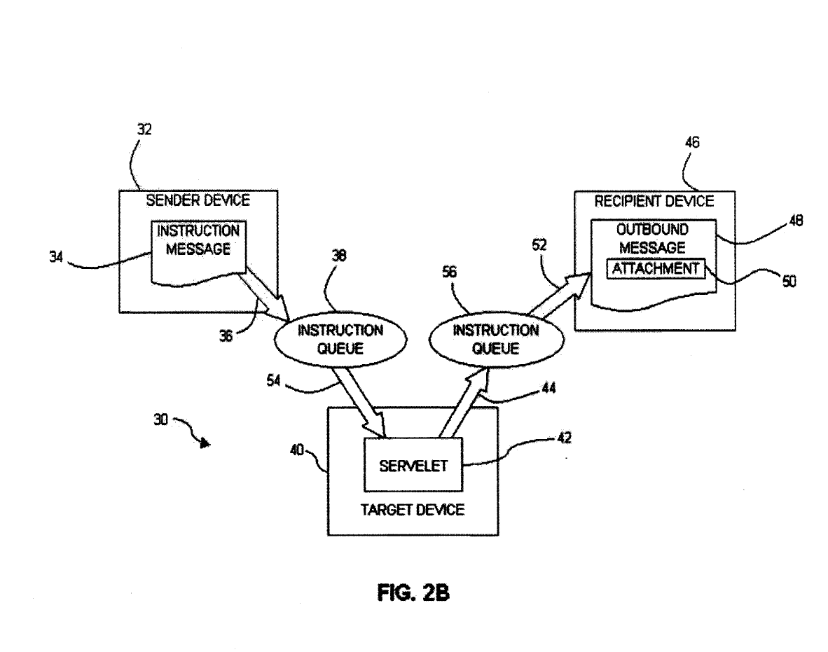

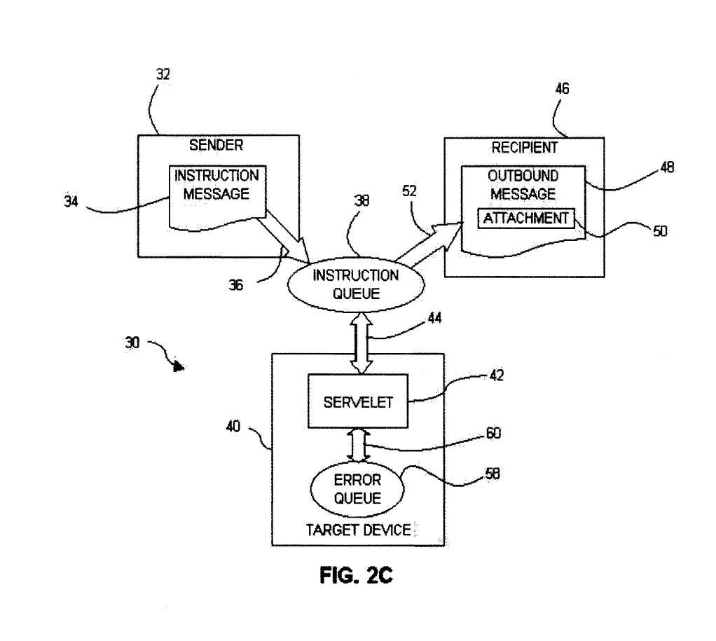

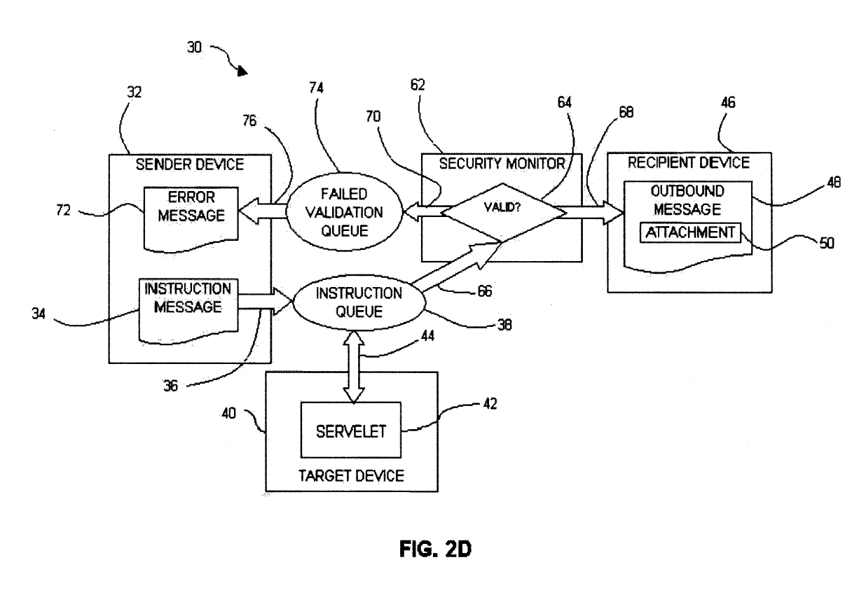

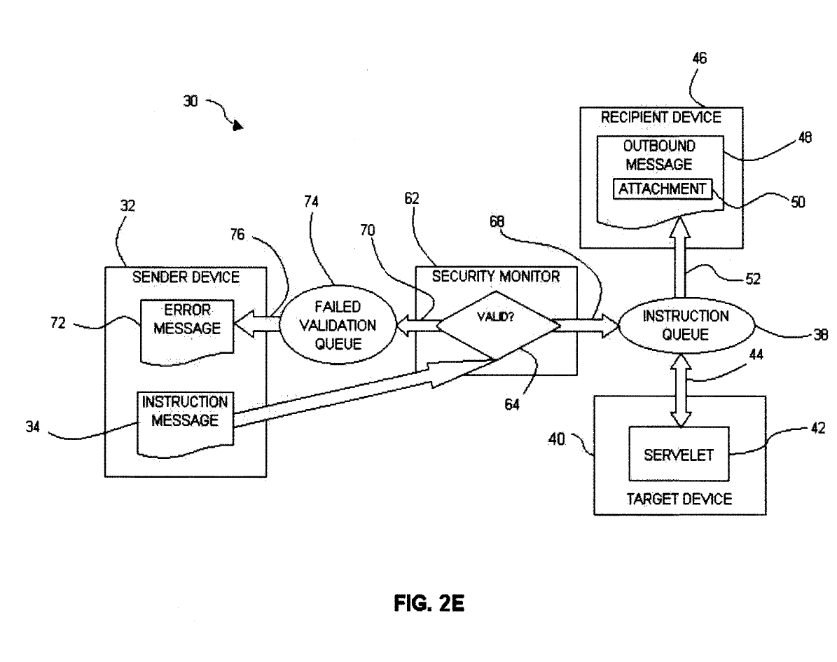

FIG. 2A is a graphical illustration of an embodiment of the invention. In FIG. 2A, system 30 includes sender device 32, recipient device 46, and target device 40, with each of the three aforementioned entities in communication with instruction queue 38. Instruction queue 38 receives instruction message 34 from sender device 32, as shown by arrow 36. Referring to element 44, servelet 42 on target device 40 may be polling instruction queue 38 for incoming communication at a pre-defined frequency. Upon detecting instruction message 34 in queue 38, servelet 42 may execute a subroutine in accordance with the instructions contained in message 34. Upon completion of the subroutine, servelet 42 may communicate with instruction queue 38 to deliver outbound message 48 to one or more recipients 46, as depicted by element 52. Depending upon the specific request from instruction message 34, outbound message 48 may additionally include one or more attachments 50 with message 48.

In one variation of the present invention, message 34 includes one or more instructions specifying a content description to be searched for on a target digital storage medium. The target digital storage medium is optionally accessible to a user computer. Instruction queue 38 may or may not reside on the target digital storage medium. In a refinement of the present variation, message 34 further includes a step of preserving the electronically stored information found by the search. Preservation of such electronically stored information may be realized by making a duplicate of the information. Such duplicates are typically transferred to a predetermined storage location, such as an email inbox or a predetermined directory. In a further refinement, the relevancy of the electronically stored information is evaluated so that only sufficiently relevant information is duplicated. Various techniques for evaluating relevancy know to those skilled in the aret of data search may be deployed. One simple technique is to determine the presence of one or more key words in the electronic information. Information perservation may also be realized by creating a report of user attempts to alter electronic information. Such reports are then used to undertake appropriate remedial action to ensure that relevant information is preserved.

FIG. 2B illustrates another embodiment of system 30 in FIG. 2A, further including a second instruction queue 56. The second queue 56 exemplarily allows servelet 42 to receive a message from first queue 38 and send a message through second queue 56, or vice versa. As an example, an administrator may wish for servelet 42 to receive instruction message 34 through a first protocol (e.g. Post Office Protocol) and send outbound message 48 through a second protocol (e.g. File Transfer Protocol). A single queue may not have the capability to function with both of the mentioned protocols, in which case a second queue may be necessary to send and receive the messages as desired. The configuration of two queues may also be useful for increasing the efficiency of system 30. For example, a single queue may be operating at its peak level, thus precluding any further message from being exchanged through the queue. In this situation, adding an additional queue to system 30 could redirect some of the traffic from first queue 38 to second queue 56.

FIG. 2C shows another embodiment of the present invention, in which system 30 includes an error queue 58 in communication with servelet 42. The purpose of error queue 58 is to allow servelet 42 to resume a previously interrupted subroutine. In a fashion similar to system 30 of the previously described embodiments, servelet 42 may execute a subroutine in accordance with instructions in message 34 after receiving message 34 from instruction queue 38. Error queue 58 may exemplarily function to store information relating to the progress of the subroutine being executed by servelet 42. This information can include a file path, hash value, logical address, or any other information that may allow servelet 42 to determine the starting point of a subroutine subject to a previous subroutine that may have been unexpectedly terminated.

In one exemplary scenario, servelet 42 stores information to error queue 58 at the end of a time interval tᵢ, where the subscript represents the specific interval in which the information is stored to error queue 58. The time interval may be defined by a pre-determined frequency f, where tᵢ is mathematically equivalent to 1/f. Additionally, the particular interval may be stored to queue 58 along with the information stored for that particular interval. If, for example, servelet 42 is unexpectedly terminated at a time tₖ, in which tₖ>tᵢ, servelet 42 may communicate with error queue 58 to recover the information most recently stored in error queue 58 and resume operation from the point of error.

FIGS. 2D-2E show further embodiments of system 30 illustrated in FIG. 2A, in which system 30 includes security monitor 62 and failed validation queue 74. With reference to FIG. 2D, instruction queue 38 receives instruction message 34 from sender device 32, as depicted by element 36. In a fashion similar to the previously described embodiments, servelet 42 may receive message 34 and subsequently execute a subroutine in accordance with the instructions contained in message 34. Upon completion of the subroutine, servelet 42 may send outbound message 48 to security monitor 62, wherein outbound message 48 may contain one or more attachments 50.

Security monitor 62 functions to validate the correctness of the specified recipient. Monitor 62 may, for example, validate the stated recipient of message 34 to ensure that the message 34 is not sent to an undesired user. As another example, security monitor 62 could verify the contents of outbound message 48 to examine the information for Decision module 64 pictorially represents the high-level logic of security monitor 62. In the case of a correct recipient, security monitor 62 may send outbound message 48 to the intended recipient, as shown by arrow 68. If security monitor 62 determines that the recipient is not correct, error message 72 may be sent to failed validation queue 74, as shown by arrow 76. Error message 72 may then be sent to sender device 32 to inform sender 32 of the failed validation.

With reference to FIG. 2E, security monitor 62 may receive instruction message 34. Security monitor 62 may then validate the correctness of the specified recipient, as pictorially depicted by decision module 64. If the intended recipient is valid, security monitor 62 may send instruction message 34 to instruction queue 38 as shown by arrow 68. In accordance with the previously described embodiments, servelet 42 on target device 40 may receive instruction message 34 from queue 38, execute a subroutine in accordance with the instructions contained in message 34, and accordingly send outbound message 48 to one or more recipients 46 with one or more optional attachments 50.

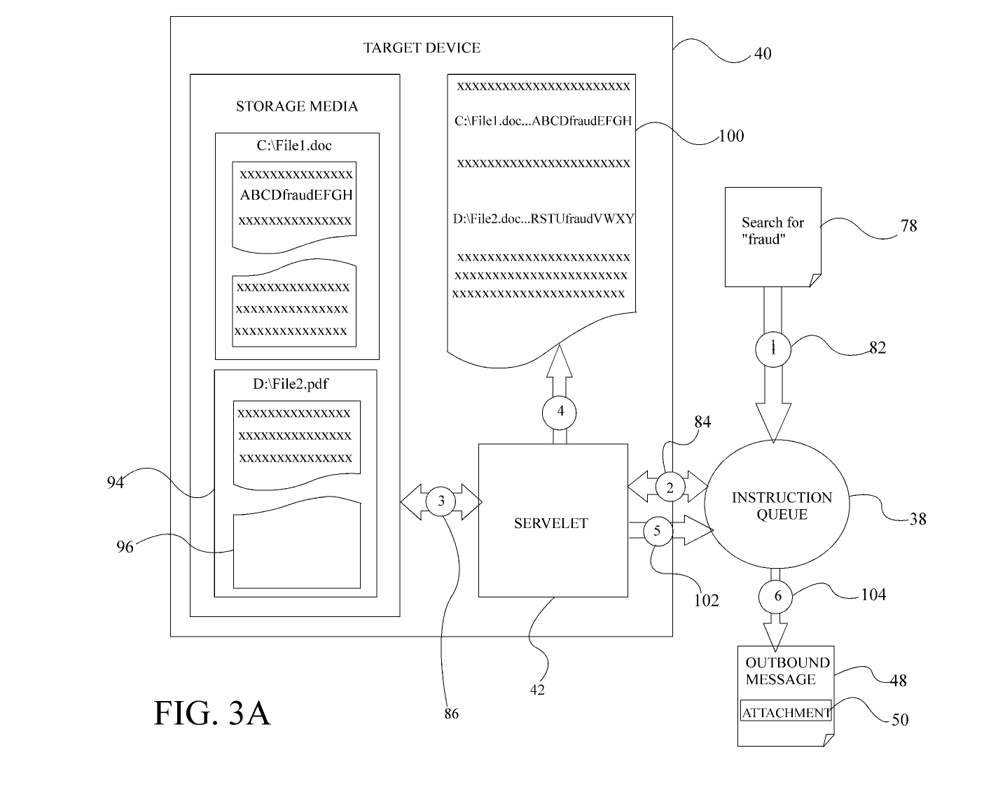

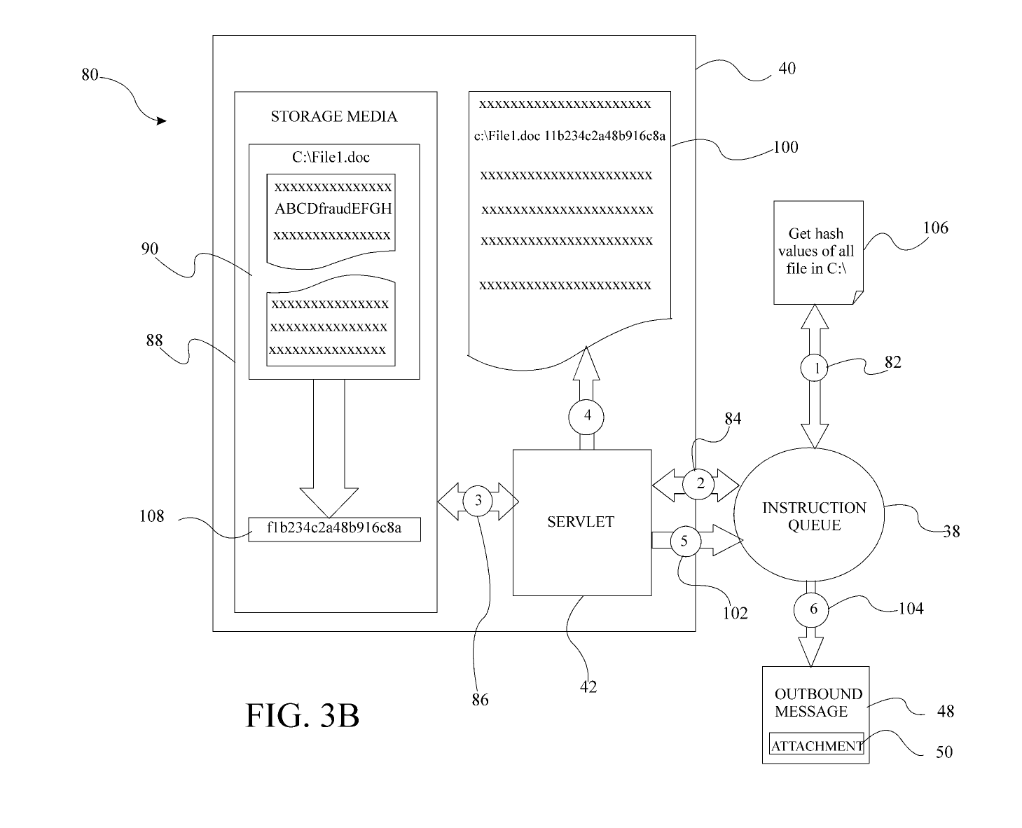

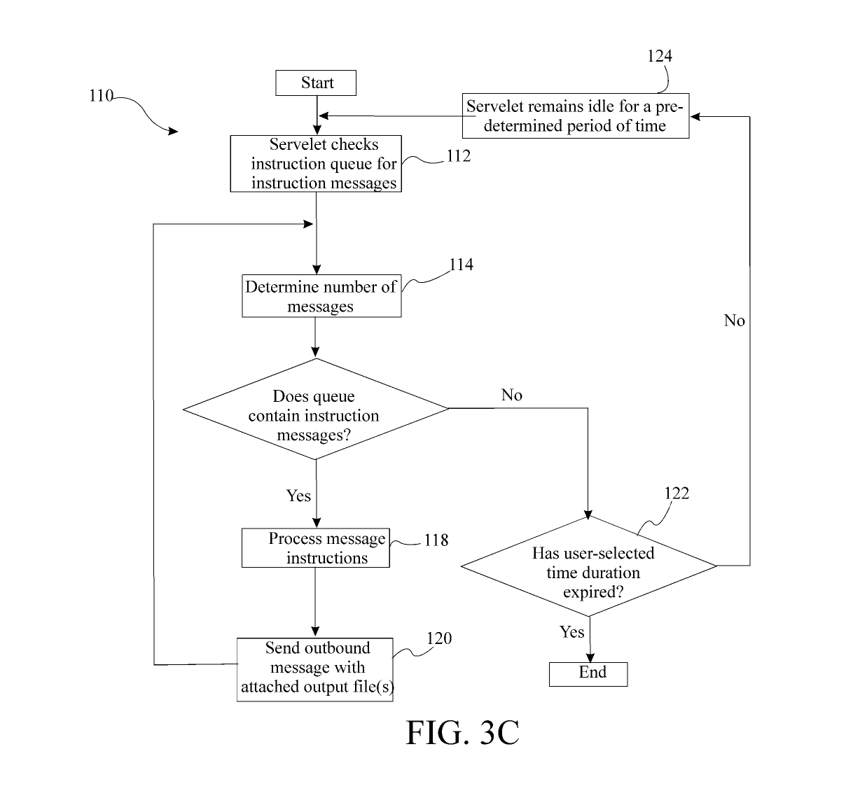

FIG. 3A shows an exemplary scenario of a target device 40 that is in communication with instruction queue 38. Storage media 88 is in communication with target device 40. Although storage media 88 is illustratively shown to reside within target device 40, storage media 88 need not reside on device 40 so long as they are in communication. Accordingly, those skilled in the art will recognize that storage media 88 may include a hard disk drive, a flash drive, or any other media capable of storing information and communicating with target device 40. Servelet 42 is also shown in communication with target device 40, storage media 88, and instruction queue 38. Although pictorially shown to reside within target device 40, servelet 42 may reside on storage media 88, a second storage media (not shown), or any other media that may host a functional servelet, as described above.

As shown in FIG. 3A, instruction message 78 is received by instruction queue 38. For demonstrative purposes, message 78 is shown to include a single search instruction although in actual implementation the message may include more instructions than shown. Servelet 42 may be polling instruction queue 38 for incoming communication, as shown by element 84. Upon detecting instruction message 78 in queue 38, servelet 42 communicates with storage media 88 to execute a subroutine in accordance with search instruction 78.

In the example shown in FIG. 3A, servelet 42 communicates with storage media 88 to search for any files containing the search term (e.g. “fraud”), as depicted by element 86. In one scenario, servelet 42 may perform a full-text index of storage media 88 after receiving instruction message 78. Alternatively, servelet 42 may have indexed storage media 88 prior to receiving instruction message 78. Two files 90,94 are demonstratively shown to contain the search term. The first file 90 is shown to contain the search term in its metadata 92, whereas the search term resides in the data portion 96 of the second file 94.

As depicted by arrow 98, servelet 42 may generate a report, as shown by element 100, containing information from the previous search of storage media 88. The report parameters may be “hard-coded”, or pre-configured, into servelet 42 or, alternatively, specified through one or more additional instructions in message 78 (not shown). These parameters may include metadata and/or file data of the files that are relevant to the search term. As shown by arrows 102 and 104, servelet 42 communicates with instruction queue 38 to send outbound message 48. Report of content 100 may be included with message 48 as an attachment 50 and/or in any other portion of message 48.

FIG. 3B shows another embodiment of the invention, similar to FIG. 3A, in which servelet 42 executes a subroutine in accordance with a different instruction message 106. In a fashion similar to FIG. 3A, servelet 42 communicates with instruction queue 38 to receive instruction message 106. Upon detecting message 106 in queue 38, servelet 42 communicates with storage media 88 to execute the instruction contained therewithin, as depicted by double-headed arrow 86. Message 106 requests servelet 42 to obtain the hash value of each file on storage media 88. It is noted that a hash value may be referenced in the art as a message digest, a digital thumbprint, a one-way hash, or the like.

In accordance with the instruction shown in message 106, file 90 encoded in storage media 88 is shown, along with its corresponding hash value 108. Hash value 108 may be any value resulting from a hash algorithm, such as MD5, SHA-1, CRC32, or any other suitable method known in the art. File 90 is representative of each file on storage media 88. Likewise, hash value 108 represents the hash value of each corresponding file on storage media 88. In a manner consistent with system 80 in FIG. 3A, servelet 42 then compiles the parameters, in this case hash values 108, into report 100. Servelet 52 then communicate with queue 38 to transmit outbound message 48 having report 100 enclosed therewith.

FIG. 3C is a flowchart illustrating an exemplary process 110 wherein a servelet receives an incoming message, processes the message, and sends an outbound message. Process 110 begins at step 112 in which the servelet communicates with an instruction queue to determine whether the queue contains any instruction messages. A number of methods may be used by the servelet to differentiate between an irrelevant message and an instruction message. As an example, the message could be an e-mail message, having three portions: a header, a body portion, and an attachment. To identify the e-mail as an instruction message, an “identifying” string could be included in one or more of these three portions. The string could be a plaintext string, for example “Instruction Message”, or an encrypted string, thus allowing the contents of the communication to be hidden from an unwanted third-party. Upon receiving the message, the servelet could have one or more strings that are pre-defined for the servelet to reference and compare to the “identifying” string to determine whether a message is legitimately an instruction message.

Again referring to step 112 of FIG. 3C, an instruction message could be identified, for example, through the sender of the message. The servelet could have one or more senders pre-defined for reference. Upon receiving the message, the servelet could compare the reference to the actual sender of the message to determine whether or not a message is an instruction message. In yet another example, a servelet may regard any message in one or more queues as an instruction message without checking the message for any pre-defined references. It is noted that a number of methods, or a combination of methods, may be used by a servelet to identify a given message as an instruction message. Furthermore, the “identifier” need not be text in the conventional sense; any data or combination of data associated with the message may be used as an identifier.

Next, at step 114, the servelet determines the quantity of instruction messages in the queue. The process then continues at step 116, at which the servelet determines whether or not the queue contains any instruction messages. If the queue contains one or more messages, process 110 proceeds to step 118, at which the servelet executes the instruction. Step 118 relates to the previously described systems 80 of FIGS. 3A-3B in which a servelet processes a search instruction (FIG. 3A, 78) and an instruction to obtain hash values (FIG. 3B, 106). However, it is noted that the processing of instructions, in accordance with step 118, may include any process in which relevant information is obtained from a target computer as directed by one or more instructions in an instruction message. Referring again to step 120 in FIG. 3C, an outbound message is sent once the servelet has finished processing the instructions. The process then returns to step 114, at which the servelet determines the new number of instruction messages in the queue.

Referring back to step 116, process 110 continues to step 122 if the queue does not contain any instruction messages. Step 122 relates to an optional parameter that may determine the total time duration that the servelet operates on the target computer. In an exemplary scenario, the servelet can be pre-configured with the parameter. For example, a servelet could contain a parameter that specifies duration of two hours. The servelet would then operate for this period of time and automatically shut down at the end of the two hours. However, the parameter need not remain constant; an instruction message could, for example, include an instruction that changes the time duration or, alternatively, disables it, thus enabling the servelet to operate for as long as the device is powered on.

Again referring to FIG. 3C, process 110 proceeds to step 124 at which the servelet remains idle for a pre-specified time period. As with the time duration parameter relating to step 122, the servelet may be pre-configured with the parameter that specifies duration of idle time. The parameter may be changed or eliminated through an instruction from an instruction message. For example, an instruction message could contain an instruction specifying idle time of two minutes, in which case the servelet would remain idle for the specified period of time, in accordance with step 124. Upon completion of the idle time duration, process 110 repeats at step 112.

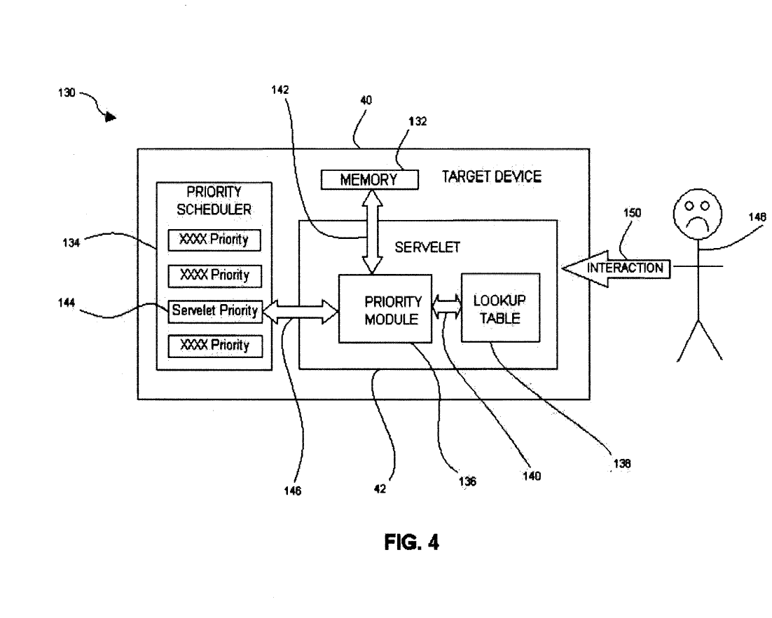

FIG. 4 shows environment 130 in accordance with an embodiment of the present invention in which target device 40 includes memory 132, servelet 42, and priority scheduler 134. Servelet 42 includes priority module 136 and lookup table 138. The purpose of element 136 is to vary priority level 144 of servelet 42. Assume, for the sake of example, that increasing or decreasing servelet priority level 144 increases or decreases memory usage by servelet 42, respectively. Also assume that user 148 interacts with target device 40 in a fashion that increases or decreases the proportion of free memory 132 on device 40. User interaction 150 does not require user 148 to be in the physical presence of device 40. User 148 could, for example, start a program on device 40 and allow the program to run overnight without any user intervention.

Still referring to FIG. 4, priority module 136 may vary servelet priority level 144 dynamically and in a way that can allow servelet 42 to remain unobtrusive to user 148. As an example, priority module 136 may interact with memory 132 at a pre-determined frequency to determine the proportion of free memory on target device 40. Module 136 may then refer to lookup table 138 to cross-reference the proportion of available memory with a pre-defined value in the lookup table which may equate to a priority level. Servelet 42 may then communicate with priority scheduler 134 to set servelet priority 144 based on the determined value from lookup table 138. Generally speaking, as user 148 interacts with target device 40 in a way that increases/decreases the available memory 132, priority module 136 communicates with memory 132 and priority scheduler 134 to increase/decrease servelet priority 144, respectively.

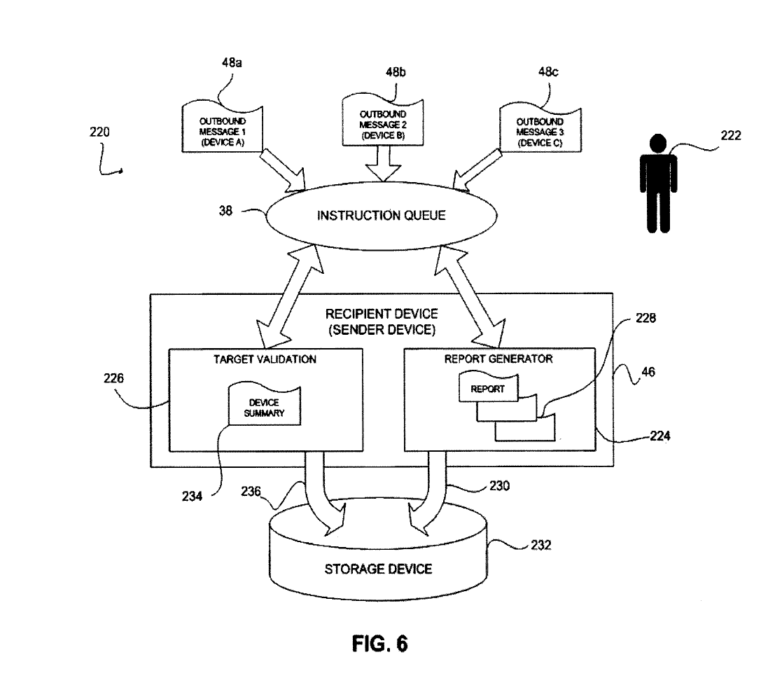

FIG. 6 shows a graphical user interface 160 for customizing certain parameters of servelet 42. Interface 160 exemplarily operates on sender device 32. Element 162 contains parameters that relate to instruction queue 38. A user may, for example, customize settings of element 162 to use a different protocol or switch from the current queue to a different queue. Although interface 160 shows parameters for the configuration of a single queue, it should be understood that additional queues may be added or customized in a similar fashion.

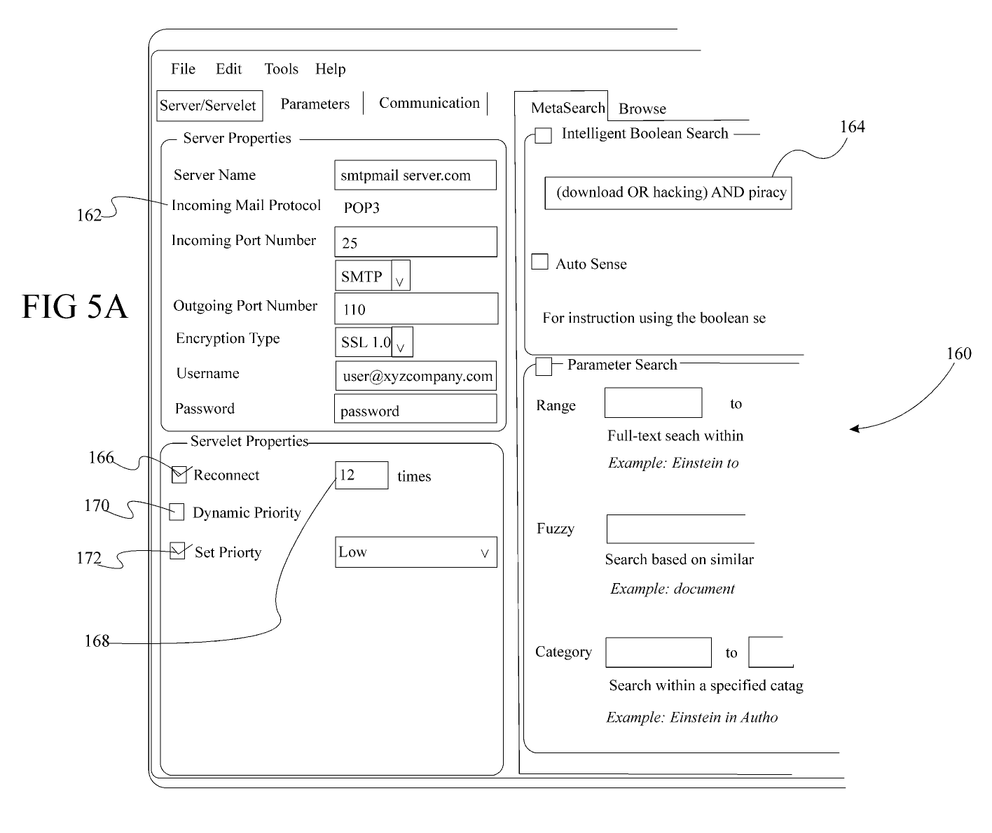

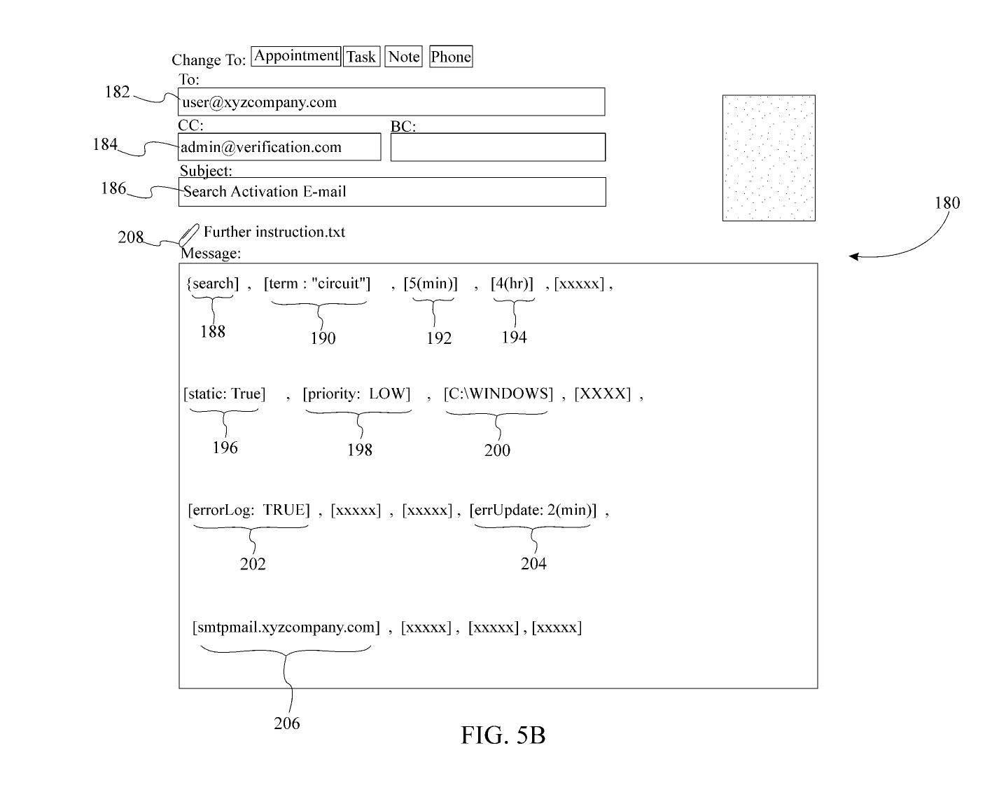

Interface 160 allows a user to customize parameters of servelet 42. For example, FIG. 3A shows servelet 42 receiving instruction message 78, which contains a search term therein. Referring back to FIG. 5A, a user could customize the contents of element 164 to change said search term. As shown by 164, a search need not be limited to a query of a single word or phrase. A search may include a Boolean search, fuzzy search, category search, or any other search that is known in the art.

Furthermore, interface 160 provides a method for enabling and customizing an error queue. FIG. 2C discusses a method for servelet 42 to store information to error queue 58. As shown in FIG. 5A, a user could select option 166 for enabling error queue 58 (shown in FIG. 2C). Customizing element 168 allows the user to change the frequency with which information is stored to 58. Interface 160 also allows a user to enable priority module 136 of FIG. 4A, as shown by element 170. A user may also choose to override priority module 136 and manually set servelet priority 144, as shown by 172.

FIG. 5B shows an exemplarily chosen e-mail message 180 that may be used as an instruction message in one or more embodiments of the present invention. Element 182 refers to the e-mail address of instruction queue 38. In one embodiment, for example, servelet 42 may access an e-mail queue and log-in as the user shown in element 182. Servelet 42 may then download e-mail 180 from the e-mail queue and process the instructions therewithin. Although one recipient is shown for the ease of demonstration, more recipients may be added to element 182.

Again referring to FIG. 5B, element 184 is the e-mail address of security monitor 62. In an embodiment of the invention, servelet 42 may be configured to identify any instruction in the “CC” field of an e-mail as a security monitor. In another embodiment, servelet 42 may require an additional parameter (not shown) in email 180 to validate the need for security monitor 62.

The purpose of element 186 is to allow servelet 42 to discern between an instruction message and an irrelevant message. A servelet may be pre-configured to look for a particular instruction, in this case the string “Search Activation E-mail” would identify e-mail 180 as an instruction message. Furthermore, a message without this string may not be identified as an instruction message and, in turn, ignored by servelet 42.

Element 188 specifies the mode in which servelet 42 should operate. For example, servelet 42 may recognize the string “search”, as specified by element 188, as an indication that further instructions may relate to searching for content on target device 40. As another example, the string “hash” may indicate to servelet 42 that the subsequent instructions relate to obtaining hash values from target device 40.

E-mail 180 directs servelet 42 to search for “circuit” in the directory “C:\WINDOWS”, as specified by elements 190 and 200, respectively. As disclosed by FIG. 3A, servelet 42 may search a file's data, metadata, or any other searchable portion of the file. Elements 192 and 194 specify the search frequency and search duration respectively. Therefore, servelet 42 would be directed by e-mail 180 to search for “circuit” at the end of every five minute interval for a duration of four hours.

Elements 196 and 198 relate to priority module 136, as describe in FIG. 4. With reference to element 196, the string “static: TRUE” may direct the servelet that a second instruction, 198 in this case, will provide a servelet priority level 144. Alternatively, a string stating “static: FALSE” may instruct servelet 42 to communicate with lookup table 138 and memory 132 to dynamically vary servelet priority 144, as discussed above in FIG. 4. Priority module 136, as directed by element 198, would in this case set servelet priority 144 to “low”.

Elements 202 and 204 relate to error queue 58, as described in FIG. 2C. The purpose of element 202 is to indicate to servelet 42 whether or not to communicate with error queue 58. As shown in e-mail 180, element 202 instructs servelet 42 to communicate with error queue 58. Element 204 specifies the frequency with which servelet 42 update error queue 58, every two minutes in this instance.

Element 206 specifies the server address of instruction queue 38. If more than one queue is used in system 30, element 26 may refer to the server address of each queues, in which each queue may use a different account name. Alternatively, element 206 may specify the server address for first queue 38, whereas the server address for each additional queue may be specified by one or more additional parameters (not shown). Alternatively, a combination of the two aforementioned methods may be used to allow servelet 42 to identify the address of each instruction queue.

Finally, element 208 relates to an attachment enclosed with e-mail 180. As suggested by the name of 108, an attachment may include further instructions in addition to those in the e-mail body.

FIG. 6 shows an aspect of the present invention, wherein system 220 includes instruction queue 38 and recipient device 46. A user 222 may optionally interact with device 46. Recipient device 46 includes report generator module 224 and target validation module 226. The purpose of module 224 is to compile the net information from outbound messages into a report 228. The report 228 may be a document incorporating the total information from the outbound message, or it may be a summary of the information. As shown by arrow 230, report 228 can be stored on storage device 232. The storage device may be any device capable of storing information thereon, such as a hard disk drive, flash drive, tape drive, or the like. Report generator 224 communicates with queue 38 to identify outbound messages in queue 38. There are a number of ways in which report generator 224 could discern between an outbound message and an irrelevant one. The report generator could be pre-configured to search for a pre-defined string, for example “outbound message”. Alternatively, report generator 224 could be pre-configured to look for messages in a pre-defined folder in queue 38.

Still referring to FIG. 6, Target validation module 226 determines which outbound message has not been received by instruction queue 38. Module 226 may be polling queue 38 with a pre-determined frequency or, alternatively, user 222 may request module 226 to execute its instructions. Validation module 226 could be configured to identify the sender of each corresponding message in queue 38. The module could then cross-references a pre-configured list of target devices to determine which messages have not been received as expected.

As an example, assume that recipient device 46 is also the sender device that originally sent four instruction messages, one to each of four separate target devices, arbitrarily referred to as target device 1,2,3, and 4, respectively. As shown in FIG. 6, three outbound messages 48a, 48b, 48c have been shown. Each message parenthetically states which target device sent the message to instruction queue 38. For instance, target device 1 sent message 48a. As mentioned, four instruction messages were originally sent by device 46 but only three outbound messages 48a, 48b, and 48c have been received at instruction queue 38.

In the example above, validation module 226 would communicate with queue 38 to determine that a fourth message (not shown) has not been received from target device 4 (also not shown). Validation module 226 would then generate a summary 234 to inform user 222 as to which devices have not yet responded. As shown by arrow 236, summary 234 may be stored on storage device 232. If, for example, user 222 is not at a generally close proximity to device 46, summary 234 could alternatively be sent to user 222 via instruction queue 38.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A computer readable medium having instructions encoded thereon that perform the following steps:
a) receiving an instruction from an instruction queue, the instruction specifying a content description to be searched for on a target digital storage medium, wherein the instruction queue does not reside on the target digital storage medium, the target digital storage medium being accessible to a user computer;
b) searching for content on the target digital storage medium specified by the content description;
c) creating a report of content that is found in step b); and
d) transferring the report to one or more predetermined users after the report is created,
wherein steps a) through d) are performed without user intervention.

2. The computer readable medium of claim 1 wherein the instruction is received at a predetermined time after the user computer is powered on or after the occurrence of a first predetermined condition while the user computer is operating.

3. The computer readable medium of claim 2 wherein searching is performed at a predetermined time after the instruction is received or after the occurrence of a second predetermined condition.

4. The computer readable medium of claim 3 wherein the first and second predetermined conditions are each independently the occurrence of a predetermined date and time.

5. The computer readable medium of claim 3 wherein the first and second predetermined conditions are each independently the occurrence of a predetermined period of user inactivity.

6. The computer readable medium of claim 1 wherein the instruction queue is an email inbox.

7. The computer readable medium of claim 1 wherein the instruction queue is a storage location.

8-9. (canceled)

10. The computer readable medium of claim 1 wherein step b) comprises a full text search.

11. The computer readable medium of claim 1 wherein step b) comprises an indexed full text search.

12. The computer readable medium of claim 1 wherein the instructions encoded thereon further include a step in which an searching index is created prior to step b).

14. The computer readable medium of claim 1 wherein step b) comprises a metadata search.

15. A computer readable medium having instructions encoded thereon that perform the following steps:
a) accessing an email message from an email inbox, the email message having one or more instructions attached to or contained therein;
b) receiving an instruction from the email message, the instruction specifying a content description to be searched for on a target digital storage medium, the target digital storage medium being accessible to a user computer;
c) searching for content on the target digital storage medium related to the content description;
d) creating a report of content that is found in step c); and
e) transferring the report via email to one or more predetermined users after the report is created,
wherein steps a) through e) are performed without user intervention.

16-17. (canceled)

18. The computer readable medium of claim 13 wherein step b) comprises a full text search.

19. The computer readable medium of claim 13 wherein step b) comprises a metadata search.

20. A computer readable medium having instructions encoded thereon that perform the following steps:
a) receiving an instruction from an instruction queue, the instruction specifying a content description to be searched for on a target digital storage medium, wherein the instruction queue does not reside on the target digital storage medium, the target digital storage medium being accessible to a user computer;
b) searching for electronically stored information on the target digital storage medium specified by the content description; and
c) preserving the electronically stored information found in step b), wherein steps a) and b) are performed without user intervention.

21. The computer readable medium of claim 20 wherein step c) comprises:
i) making a duplicate of the electronically stored information found in step b)

22. The computer readable medium of claim 21 wherein step c) comprises:
ii) transferring the duplicate to a predetermined storage location.

23. The computer readable medium of claim 22 wherein the duplicate is transferred to a predetermined email inbox.

24. The computer readable medium of claim 21 having additional instructions encoded thereon to further perform the following step of:
d) evaluating the relevancy of the electronically stored information found in step b).

25. The computer readable medium of claim 24 wherein step i) is only performed if the electronically stored information is sufficiently relevant.

26. The computer readable medium of claim 24 wherein step d) comprises determining the presence of one or more key words in the electronic information

27. The computer readable medium of claim 20 having additional instructions encoded thereon to further perform the following step:
e) creating a report of user attempts to alter electronic information.

28. The computer readable medium of claim 20 wherein the instruction queue is an email inbox.

29. The computer readable medium of claim 20 wherein the instruction queue is a storage location.
